(19) United States
(12) Patent Application Publication
(10) Pub. No.: US 2003/0184884 A1
(43) Pub. Date: Oct. 2, 2003

(54) Optical scanner apparatus with an optical well imaging device

(75) Inventor: Shih-Zheng Kuo, Taipei (TW)

Correspondence Address: Powell, Goldstein, Frazer & Murphy, LLP, Suite 600, 1001 Pennsylvania Avenue, Washington, DC, 20004, US

(73) Assignee: UMAX DATA SYSTEMS INC.

(21) Appl. No.: 10/107,451

(22) Filed: Mar. 28, 2002

(51) Int. Cl. G02B 27/02

(52) U.S. Cl. 359/806

(57) ABSTRACT

An imaging device for an optical scanning module of an optical scanner apparatus is disclosed. By use of an optical well imaging device to replace the conventional micro-lens imaging device to receive the straight imaged light, which is generated from the scanning object is illuminated by an illuminant. Moreover, the height of the non-inducted region on the optical sensor is higher enough to block the interfered light that is formed by other beam of the imaged light such that the optical sensor can receive the part of the beam of the straight imaged light and will not be interfered. Therefore, by use of the optical well imaging device, the light dispersion effect can be improved and the imaging data can be completely focused on the optical sensor to obtain an optimum resolution and the best MTF (modulation transfer function).

### BACKGROUND OF THE INVENTION

1. Field of the Invention

The present invention generally relates to an optical scanner apparatus, and more particularly to an imaging device of an optical scanning module to improve the light dispersion effect and obtain the better MTF (modulation transfer function).

2. Description of the Prior Art

Scanner devices, such as flatbed scanners, are well known in the art and produce machine-readable image data signals that are representative of scanned object, such as a photograph or a page of printed text. In a typical scanner application, the imaging data is produced by a scanner may be used by personal computer to reproduce an image of the scanned object in a suitable display device, such as a CRT (cathode ray tube) or a print.

Flatbed scanners are widely used with computer systems for converting printed data into imaging signals. An optical scanning module is the most important component of the flatbed scanner. The scanning module commonly comprises a housing with an opening for receiving light transmitted from a scanning object, an optical sensor such as CCD (charge coupled device) installed inside the housing for converting the transmitted light into corresponding image signals, and a plurality of lenses for focusing the transmitted light onto the optical sensor.

A typical flatbed scanner may include illumination and optical systems to accomplish scanning of the object. The illumination system illuminates a portion of the object (commonly referred to as a “scan region”), whereas the optical system collects light reflected by the illuminated scan region and focuses a small area of the illuminated scan region (commonly referred to as a “scan line”) onto the surface of a optical sensor positioned within the optical scanner apparatus. Image data representative of the entire object then may be obtained by sweeping the scan line across the entire object, usually by moving the illumination and optical systems with respect to the object.

The illumination system may include a light source (e.g., a fluorescent or incandescent lamp or an array if light emitting diodes (LEDs)). The optical system may include a lens and/or mirror assembly to focus the image of the illuminated scan line onto the surface of the detector. Alternative, a “contact image sensor” (CIS) may be used to collect and focus light from the illuminated scan region onto the detector.

Nevertheless, the scene depth of a CIS is only about 0.3 mm. Based on the conventional flatbed optical scanner, it is very difficult to assure a scanning object sheet is focused on the CIS. Even though a small manufacture error or structure distortion will affect the quality of the optical imaging.

Referring to FIG. 1A, the reference number 100 is scanning object; reference number 102 is reflected light which is illuminated a scanning object to form a reflected light; reference number 104 is a conventional lens-imaging device; and reference number 106 is an optical sensor. In the conventional optical scanning module, the imaging data is focused on the optical sensor 106 which is according to the theorem of the formation of imaging, the reflected light 102 is transmitted from the scanning object 100 to the lens-imaging device 104, and the imaging data is communicated to the optical sensor 106. Then, the imaging data is converted into digital signal, and output to the output device, such as a printer or monitor (not shown in FIG. 1).

The response distribution curve diagram of the FIG. 1B is formed that according to the FIG. 1A. According to the theorem of the formation of image, the reflected light point 102A, 102B, and 102C of the scanning object 100, and transmitted to the lens-imaging device 104 to the optical sensor 106 to form a response distribution curve diagram 200. Due to the light dispersion effect, the two ends 202A and 202B of the response distribution curve in the response distribution curve diagram 200 are lower than the response distribution curve is formed from the light 102C (straight light) and other stream of light (not shown in FIG. 1B) between the ends 202A and 202B. Furthermore, due to the light dispersion effect, the imaging data cannot focus completely on a point such that the resolution of the imaging data on the two ends 202A and 202B is bad. Therefore, the resolution of the scanning object 100 will be degraded.

Furthermore, due to the lens-imaging device 104 will cause the light dispersion effect such that the imaging data cannot focus completely on the optical sensor 106. Furthermore, the reflected light 102 is interfered by other beam of the reflected light such that the MTF (modulation transfer function) will be obtained a poor value for scanning.

### SUMMARY OF THE INVENTION

It is an object of this invention to provide an imaging device to replace the lens-imaging device to economize the production cost of the optical scanner apparatus.

It is still another object of this invention to improve the light dispersion effect during scanning the scanning object.

It is yet another object of this invention to improve the optimum MTF (modulation transfer function) to enhance the resolution of the scanning object.

According to aforementioned, the present invention is provided an imaging device to replace the conventional lens-imaging device that is used as imaging device for conventional optical scanner apparatus. In the present invention, an optical well imaging device is used to replace the lens-imaging device to transmit the imaged light that is generated from the scanning object is illuminated by an illuminant, and then transmitted the imaged light to the optical sensor. The non-inducted region has a height around the optical sensor that is used to block the other beam of the imaged light to distribute, such that the optical sensor only receive the straight imaged light in front of the optical sensor. Therefore, the imaged light can be completely transmitted to the optical sensor to improve the light dispersion effect to obtain an optimum MTF.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is showing a imaged light is transmitted to a conventional lens-imaging device of an optical scanner apparatus;

FIG. 1B is a response distribution curve diagram, which is formed according to the imaged light is transmitted to lens-imaging device;

FIG. 2 is a block diagram of the optical scanner apparatus with an optical well imaging device in accordance with a device disclosed herein;

FIG. 3 is showing a vertical view of the optical well imaging device to receive stream of light in front of the optical sensor in accordance with a device disclosed herein; and

FIG. 4 is a schematic vertical view of the optical scanner apparatus with an optical well imaging device in accordance with a device disclosed herein.

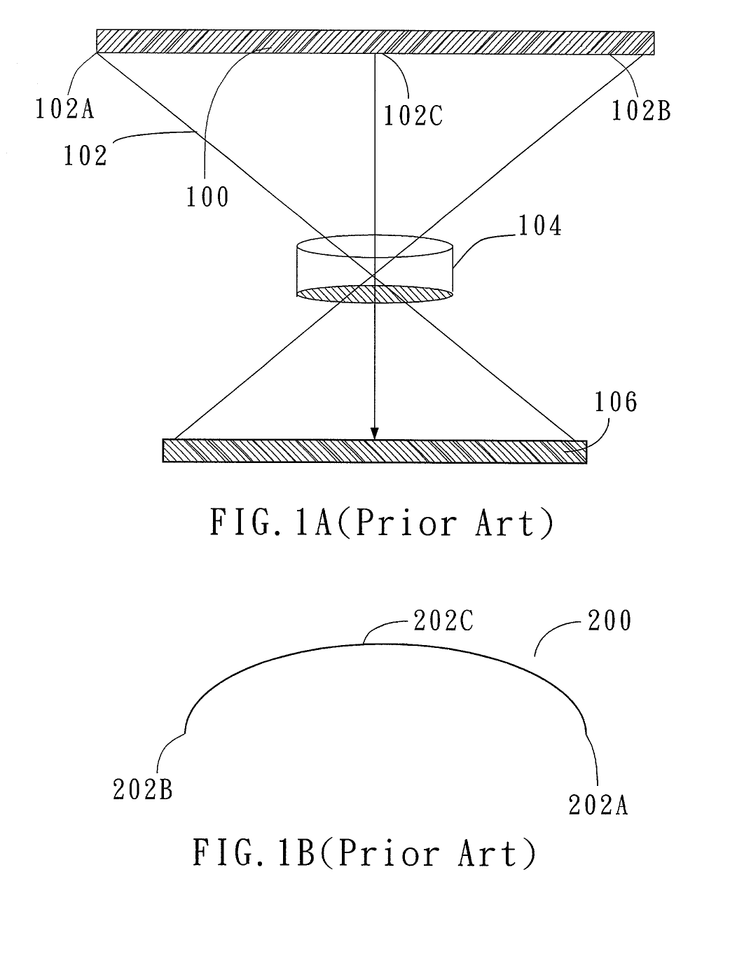

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

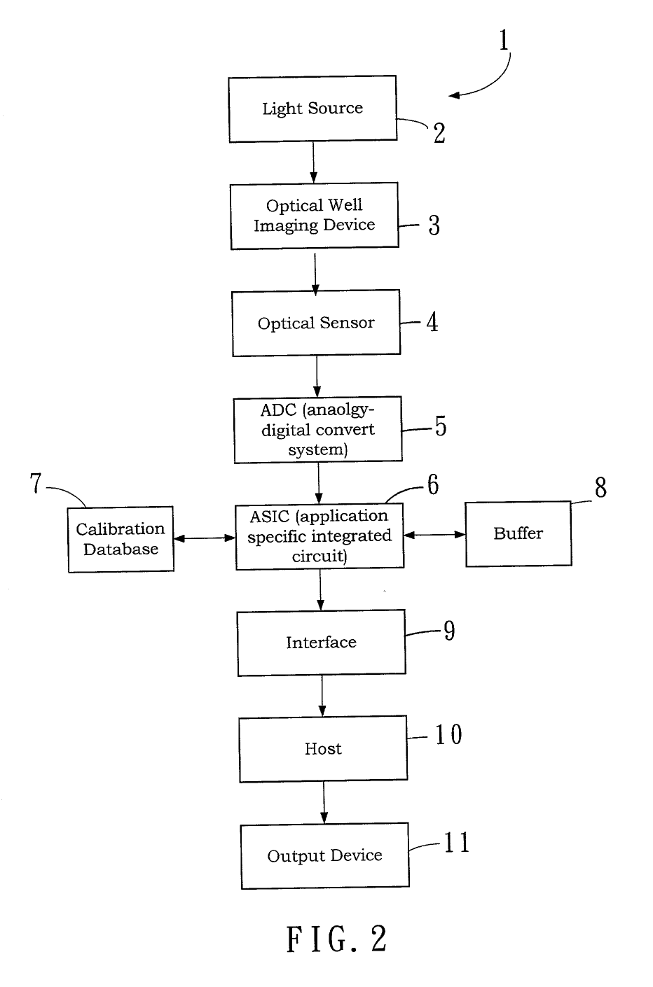

Referring to FIG. 2 is a block diagram for an optical scanner apparatus 1. In the block diagram, the optical scanner apparatus 1 utilized the light source 2 as the scanning light source 2 to illuminate the scanning object (not shown). Then, the imaged light is transmitted from the scanning object to the imaging device 3 such as an optical well imaging device, which is used to replace the conventional lens-imaging device such that the optical sensor 4 only received the imaged light in front of the optical sensor 4 to reduce the interfered light from the other light source. Therefore, the light dispersion effect can be improved and an optimum MTF (modulation transfer function) can be obtained. Next, the imaging data is communicated to the ADC (analogy digital convert system) 5 to convert the analogy signal into the digital signal. Thereafter, the digital signal is communicated to the ASIC (application specific integrated circuit) 6. The variety of the chip set within the ASIC 6 to process the requiring function for user's command. When the entire of the imaging data cannot be processed, the part of the imaging data will communicate to the buffer 8 to store the part of the imaging data until the ASIC 6 accessed from the buffer and processed the imaging data. Furthermore, the imaging data is also communicated to the calibration database 7 to calibrate the imaging data (this step can be an optional step). Next, the imaging data is communicated to the host 10 by interface 9, wherein the interface 9 can be a USB (universal serial bus), parallel port, SCSI TCP (small computer system interface transmission control protocol), or IR communication (infrared ray communication). Then, the imaging data is communicated to the output device 11, such as monitor, printer, or PDA (personal digital assistant), to display the imaging data of the scanning object. In this block diagram, the light source 2, calibration database 7, buffer 8, interface 9, host 10, and output device 11 are article except for an optical imaging device, an optical sensor 4, ADC 5, and ASIC 6. Further, the optical scanner apparatus 1 utilized these articles to increase the capability, and improve the dpi (dots per inch), and imaging quality.

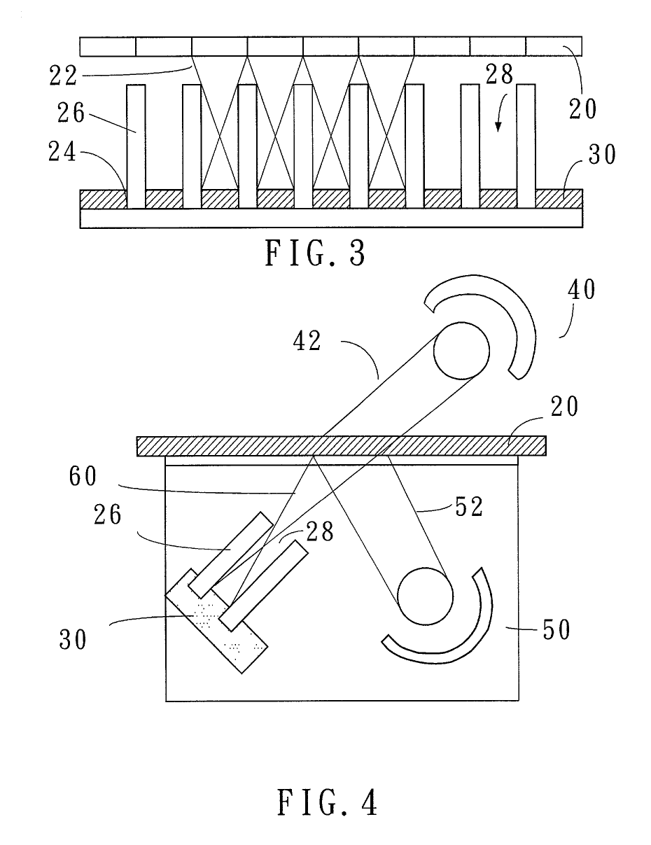

Then, referring to FIG. 3, which is showing a imaged light 22, such as a reflected light or a transparent light, is transmitted from the scanning object 20 that is illuminated by an illuminant to the imaging device, and then the imaging light 22 is transmitted to the optical sensor 30, wherein the optical sensor 30 can be a CIS (contact image sensor) or CCD (charge coupled device). In one embodiment of the present invention is provided an optical well imaging device 28 with a plurality of optical gate 26 around the non-inducted region 24 of the optical sensor 30, which is corresponding to each pixel of the optical sensor 30 to replace the conventional optical scanner apparatus with a micro-lens imaging device to receive the imaging light. In the preferable embodiment of the present invention, the pluralities of optical gate 26 has a height to block the other beam of the imaged light to interfere the straight imaged light that is transmitted to the optical sensor 30, wherein the height of the plurality of the optical gate 26 is higher enough to block the interfered imaged light such that the optical sensor 30 only received the straight imaged light which is in front of the optical sensor 30, and the space between the plurality of the optical gate 26 has same width, and the space between the plurality of the optical gate 26 is smaller than each pixel of the optical sensor 30.

According to aforementioned, the optical well 26 is used as an imaging device that can receive the straight imaged light and the height of the plurality of the optical gate 26 around the non-inducted region 24 is higher enough to block the interfered imaged light such that the straight imaged light can completely transmit to the optical imaging device 28 and communicate the complete imaging data. When the complete imaging data is converted analogy signal into digital signal by ADC, the imaging data can be completely to display to the output device such that the MTF can be improved and the resolution of the imaging data also can be enhanced.

Next, referring to the FIG. 4, which is a vertical view of the optical scanning module of an optical scanner apparatus with an optical well imaging device 28. In the FIG. 4, there are two optical scanning modules, one is transparent scanning module 40 that is used to scan transparent scanning object, another is reflected scanning module 50 that is used to scan reflected scanning object. When the illuminant 42 is illuminated the transparent scanning object 20, the imaged light 60 is transmitted from the transparent scanning object 20 to the optical well imaging device 28. Then, the imaging data is transmitted to the optical sensor 30 and focused on the optical sensor 30. When the illuminant 52 is illuminated the reflected scanning object 20 to cause the imaged light 60. Then, the imaged light 60 is transmitted to the optical well imaging device 28, and the imaging data is transmitted to the optical sensor 30 and focused completely on the optical sensor 30.

According to abovementioned, regardless of the transparent scanning object or reflected scanning object, the optical gate has a height to block the interfered imaged light to interfere the straight imaged light transmitted into the optical sensor, such that the optical sensor only received the straight imaged light and the imaging data can be completely focused on the optical sensor. Therefore, the light dispersion effect issue and the poor MTF can be improved, and the resolution of the imaging data can be enhanced.

Although specific embodiments have been illustrated and described, it will be obvious to those skilled in the art that various modifications may be made without departing from what is intended to be limited solely by the appended claims.

What is claimed is:

1. An optical scanner apparatus, said optical scanner apparatus comprising:
an illuminant illuminating a scanning object to form a imaged light;
an imaging device receiving said imaged light; and
a plurality of optical gate allowing a part of beam of imaged light to an optical sensor, wherein said plurality of said optical gate on a non-inducted region of said optical sensor and said optical sensor receiving said part of beam of imaged light from said imaging device.

2. The optical scanner apparatus according to claim 1, wherein said imaged light comprises a reflected light.

3. The optical scanner apparatus according to claim 1, wherein said imaged light comprises a transparent light.

4. The optical scanner apparatus according to claim 1, wherein said imaging device is an optical well imaging device.

5. The optical scanner apparatus according to claim 1, wherein the space between said plurality of said optical gate has same width.

6. The optical scanner apparatus according to claim 5, wherein said space between said pluralities of said optical gate is smaller than each pixel of said optical sensor.

7. The optical scanner apparatus according to claim 1, wherein the height of said optical gate is higher enough to block said interfered light from other beam of said imaged light.

8. The optical scanner apparatus according to claim 1, further comprises an analogy-digital convert system receiving an imaging data that communicating from said optical sensor and converting said imaging data into a digital signal.

9. The optical scanner apparatus according to claim 1, further comprising an application specific integrated circuit receiving said digital signal that communicating from said analogy-digital convert system and processing said digital signal.

10. An optical scanner apparatus, said optical scanner apparatus comprising:
an illuminant illuminating a scanning object to form a imaged light;
an imaging device receiving said imaged light;
a plurality of optical gate allowing a part of beam of imaged light to an optical sensor, wherein said plurality of said optical gate on a non-inducted region of said optical sensor, and said optical sensor receiving said part of beam of imaged light from said imaging device;
an analogy-digital convert system receiving an imaging data that communicating from said optical sensor and converting said imaging data into a digital signal; and
an application specific integrated circuit receiving said digital signal that communicating from said analogy-digital convert system and processing said digital signal.

11. The optical scanner apparatus according to claim 10, wherein said imaged light comprises a reflected light.

12. The optical scanner apparatus according to claim 10, wherein said imaged light comprises a transparent light.

13. The optical scanner apparatus according to claim 10, wherein said imaging device is an optical well imaging device.

14. The optical scanner apparatus according to claim 10 wherein said optical sensor is a contact image sensor.

15. The optical scanner apparatus according to claim 10, wherein said optical sensor is a charge coupled device.

16. The optical scanner apparatus according to claim 10, wherein the space between said plurality of said optical gate has same width.

17. The optical scanner apparatus according to claim 16, wherein said width between said plurality of said optical gate is smaller than each pixel of said optical sensor.

18. An optical scanner apparatus with an optical well imaging device, said optical scanner apparatus comprising:
an illuminant illuminating a scanning object to form a imaged light;
an optical well imaging device receiving said imaged light;
a plurality of optical gate having the same width in-between on an optical sensor and allowing a part of beam of straight imaged light into said optical sensor, wherein said plurality of said optical gate has a height is higher enough to block a interfered imaged light from other beam of said imaged light, and said optical sensor receiving said part of beam of said straight imaged light from said optical well imaging device;
an analogy-digital convert system receiving an imaging data that communicating from said optical sensor and converting said imaging data into a digital signal; and
an application specific integrated circuit receiving said digital signal that communicating from said analogy-digital convert system and processing said digital signal.

19. The optical scanner apparatus according to claim 18, wherein said imaged light comprises a reflected light.

20. The optical scanner apparatus according to claim 18, wherein said imaged light comprises a transparent light.

21. The optical scanner apparatus according to claim 18, wherein said optical sensor is a contact image sensor.

22. The optical scanner apparatus according to claim 18, wherein said optical sensor is a charge coupled device.

23. The optical scanner apparatus according to claim 18, wherein said width between said pluralities of said optical gate is smaller than each pixel of said optical sensor.
